(19) United States
(12) Patent Application Publication
(10) Pub. No.: US 2016/0257109 A1
(43) Pub. Date: Sep. 8, 2016

(54) MANUFACTURING APPARATUS AND MANUFACTURING METHOD FOR THERMAL TRANSFER PRINT SHEET

(71) Applicant: CASIO COMPUTER CO., LTD., Tokyo (JP)

(72) Inventors: Jun KOJIMA, Tokyo (JP); Tsutomu KOBAYASHI, Tokyo (JP)

(73) Assignee: CASIO COMPUTER CO., LTD., Tokyo (JP)

(21) Appl. No.: 15/055,767

(22) Filed: Feb. 29, 2016

(30) Foreign Application Priority Data
Mar. 3, 2015 (JP) 2015-041006
Mar. 9, 2015 (JP) 2015-045807

(51) Int. Cl. G06F 3/12

(52) U.S. Cl. CPC B41C 1/06

(57) ABSTRACT

A CPU reads out image data from a frame memory line by line, performs logical addition of each bit of readout original image data corresponding to one line and a corresponding bit of each image data acquired by shifting the original image data by one to four bits, and thereby generates image data whose width has been enlarged by four bits. When writing the image data enlarged in the leftward and rightward directions in a ring buffer, the CPU generates image data on a transfer base material which has been enlarged in the upward and downward directions by copying or logical addition. A transfer base material transfer control section outputs the image data on the transfer base material written in the ring buffer for each line to a print head control section under the control of the CPU at predetermined timing.

### CROSS-REFERENCE TO RELATED APPLICATIONS

This application is based upon and claims the benefit of priority from the prior Japanese Patent Applications No. 2015-041006, filed Mar. 3, 2015 and No. 2015-045807, filed Mar. 9, 2015, the entire contents of which are incorporated herein by reference.

### BACKGROUND OF THE INVENTION

1. Field of the Invention

The present invention relates to a manufacturing apparatus and a manufacturing method for a thermal transfer print sheet.

2. Description of the Related Art

Conventionally, there are known methods for printing a desired image or a design such as a logo on a transfer target medium such as a fabric product including a T-shirt, a sweat shirt, or work clothes, wood, or a metal plate. For example, Japanese Patent Application Laid-Open (Kokai) Publication No. 2013-068862 discloses a method and an apparatus for creating a thermal transfer print sheet by fixing an image to be thermally transferred and an adhesive transfer base material on a releasable sheet.

When a transfer object is to be transferred to a transfer target medium, a thermal transfer print sheet is cut in a proper size and superimposed on the transfer target medium such as a T-shirt with a surface (hereinafter referred to as “obverse surface”) where the transfer object (an image to be thermally transferred to the transfer target medium) is fixed opposing the transfer target medium. Then, heat and pressure are applied to the reverse surface of the thermal transfer print sheet by ironing or the like to fix the image on the transfer target medium.

However, in the above-described technique where image data on a transfer base material is separately generated, a memory area for the image data on the transfer base material needs to be secured, which results in an increased memory capacity. Also, in this technique, a large, thin, adhesive film remains outside the area of a transfer image, resulting in poor finishing after printing by ironing.

### SUMMARY OF THE INVENTION

In accordance with one aspect of the present invention, there is provided a manufacturing apparatus for a thermal transfer print sheet provided with a toner layer that serves as a transfer image to be thermally transferred to a transfer target medium and an adhesive transfer base material layer, the manufacturing apparatus comprising: an acquisition section which acquires area information regarding an area occupied by the transfer image; a derivation section which derives an area enlarged so as to include at least the area occupied by the transfer image and have an area shape corresponding to the transfer image, based on the area information acquired by the acquisition section; and a generation section which generates the transfer base material layer on the enlarged area, which is derived by the derivation section.

In accordance with another aspect of the present invention, there is provided a manufacturing apparatus for a thermal transfer print sheet provided with a toner layer that serves as an image to be thermally transferred to a transfer target medium and an adhesive transfer base material layer, the manufacturing apparatus comprising: a first storage section which holds data of an image to be thermally transferred as transfer image data; a generation section which generates image data on the transfer base material by enlarging the transfer image data in the first storage section for each line; a second storage section which temporarily holds the image data on the transfer base material generated by the generation section in units of predetermined number of lines; and an output section which outputs the image data on the transfer base material held in the second storage section for each line.

In accordance with another aspect of the present invention, there is provided a manufacturing method for a thermal transfer print sheet provided with a toner layer that serves as a transfer image to be thermally transferred to a transfer target medium and an adhesive transfer base material layer, the manufacturing method comprising: acquiring area information regarding an area occupied by the transfer image; deriving an area enlarged so as to include at least the area occupied by the transfer image and have an area shape corresponding to the transfer image, based on the area information; and generating the transfer base material layer on the enlarged area.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The present invention can be more deeply understood by the detailed description below being considered together with the following drawings.

FIG. 1 is a sectional view showing the internal arrangement of a thermal transfer print sheet manufacturing apparatus according to an embodiment of the present invention;

FIG. 2 is a circuit block diagram showing the controller of the thermal transfer print sheet manufacturing apparatus according to the present embodiment;

FIG. 3 is a flowchart for explaining a method of generating image data on a transfer base material (T) by using the thermal transfer print sheet manufacturing apparatus according to the present embodiment;

FIG. 4 is a conceptual view for explaining the method of generating image data on a transfer base material (T) by using the thermal transfer print sheet manufacturing apparatus according to the present embodiment;

FIG. 5 is also a conceptual view for explaining the method of generating image data on a transfer base material (T) by using the thermal transfer print sheet manufacturing apparatus according to the present embodiment;

FIG. 6 is also a conceptual view for explaining the method of generating image data on a transfer base material (T) by using the thermal transfer print sheet manufacturing apparatus according to the present embodiment;

FIG. 7 is also a conceptual view for explaining the method of generating image data on a transfer base material (T) by using the thermal transfer print sheet manufacturing apparatus according to the present embodiment;

FIG. 8 is a conceptual view for explaining timing at which image data on a transfer base material (T) is transmitted to a print head control section by a transfer base material (T) transfer control section according to the present embodiment;

FIG. 9A and FIG. 9B are conceptual views showing a toner image based on original image data and a toner image of a transfer base material (T) which is to be generated with respect to the original image data;

FIG. 10A, FIG. 10B, and FIG. 10C are conceptual views for explaining an example of the method of generating image data on a transfer base material (T) according to the present embodiment;

FIG. 11A, FIG. 11B, and FIG. 11C are also conceptual views for explaining an example of the method of generating image data on a transfer base material (T) according to the present embodiment;

FIG. 12A, FIG. 12B, and FIG. 12C are also conceptual views for explaining an example of the method of generating image data on a transfer base material (T) according to the present embodiment;

FIG. 13A, FIG. 13B, and FIG. 13C are also conceptual views for explaining an example of the method of generating image data on a transfer base material (T) according to the present embodiment;

FIG. 14 is also a conceptual view for explaining an example of the method of generating image data on a transfer base material (T) according to the present embodiment;

FIG. 15A and FIG. 15B are also conceptual views for explaining an example of the method of generating image data on a transfer base material (T) according to the present embodiment; and

FIG. 16 is a schematic view for explaining a process of manufacturing a thermal transfer print sheet and a process of transferring an image according to the present embodiment.

### DETAILED DESCRIPTION OF THE PREFERRED EMBODIMENTS

Embodiments of the present invention will hereinafter be described with reference to the drawings.

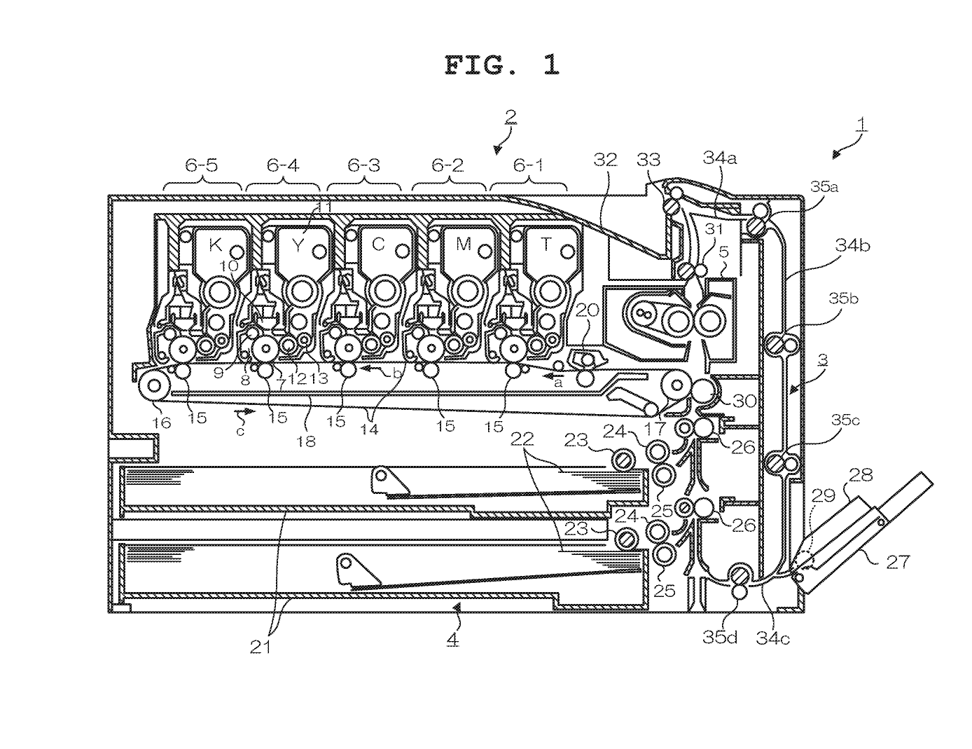

FIG. 1 is a sectional view showing the internal arrangement of a thermal transfer print sheet manufacturing apparatus 1 according to an embodiment of the present invention. The thermal transfer print sheet manufacturing apparatus 1 of the present embodiment in FIG. 1 has adopted a method of transferring a toner image to an intermediate transfer belt and secondarily transferring the toner image to paper vertically conveyed to a secondary transfer section via the intermediate transfer belt. However, the present invention is not limited to this secondary transfer method, and other transfer methods may be adopted, such as a method of directly transferring a toner image to paper.

This thermal transfer print sheet manufacturing apparatus 1 includes an image forming section 2, a two-sided printing conveyance unit 3, a sheet feeding section 4, and a fixing section 5. The image forming section 2 is structured to have five image forming units 6 (6-1, 6-2, 6-3, 6-4, and 6-5) provided side-by-side in multiple stages. The image forming unit 6-1 on the upper flow side in the paper conveyance direction (on the right side in FIG. 1) among the five image forming units 6 forms a toner image of a transfer base material (T) made of thermoplastic resin described below (a toner image developed on a photosensitive drum is hereinafter referred to as an image regardless of its shape).

The three image forming units 6-2, 6-3, and 6-4 subsequent to the above-described image forming unit 6-1 respectively form monocolor images with color toners in magenta (M), cyan (C), and yellow (Y) serving as subtractive primary colors. The fifth image forming unit 6-5 subsequent to these three image forming units 6-2, 6-3, and 6-4 forms a monochrome image in black (K). The toner images in the four colors are overlaid on a release sheet (hereinafter referred to as paper in some cases) described below to form a full-color image.

The image forming units 6-1 to 6-5 respectively have the same structures except for the color and the type of a developer contained in a developing unit. Therefore, their structures will be described using the structure of the image forming unit 6-4 as an example.

The image forming unit 6 has a photosensitive drum 7 in its lowermost portion. The peripheral surface of this photosensitive drum 7 is formed of, for example, an organic photoconductive material, and a cleaner 8, a charging roller 9, an optical writing head 10, and a developing roller 12 in a developing device 11 are arranged to contact with the peripheral surface of the photosensitive drum 7 or surround the vicinity thereof.

The developing device 11 has in its upper portion a toner container containing the toner of one of the transfer base material (T), magenta (M), cyan (C), yellow (Y), and black (K) indicated by T, M, C, Y, and K in the drawing, and has in its intermediate portion a toner replenishing mechanism oriented downward.

The developing device 11 includes the above-described developing roller 12 in a lateral opening in its lower portion, and has in its inner portion a toner agitating member, a toner supply roller 13 for supplying toner to the developing roller 12, a doctor blade for regulating a toner layer on the developing roller 12 to a predetermined layer thickness, and the like. The optical writing head 10 on the apparatus body side is arranged in proximity to the upper surface of the photosensitive drum 7 between the charging roller 9 and the developing device 11.

Also, in an area near the lower surface of the photosensitive drum 7, an intermediate transfer belt 14 is arranged, and a primary transfer roller 15 is pressed toward the lower surface of the photosensitive drum 7 with the intermediate transfer belt 14 interposed therebetween.

The intermediate transfer belt 14 is an endless-shaped transfer belt constituted by a conductive sheet-like member made of resin containing conductive carbon or an ion conductive material and extending in a flat loop shape substantially from the left end to the right end at a center portion of the apparatus body in the drawing. This intermediate transfer belt 14 is stretched between a driving roller 16 and a driven roller 17, and is cyclically driven in the counterclockwise direction in the drawing by the driving roller 16 so as to cyclically move in the counterclockwise direction indicated by arrows a, b, and c in the drawing. Also, a belt cleaner 20 is placed in contact with the surface of the intermediate transfer belt 14. This belt cleaner 20 removes waste toner from the intermediate transfer belt 14.

The photosensitive drum 7 rotates in the clockwise direction in the drawing. First, this photosensitive drum 7 is initialized when the peripheral surface of the photosensitive drum 7 is uniformly charged by electric charge from the charging roller 9. Subsequently, an electrostatic latent image is formed on the peripheral surface of the photosensitive drum 7 by optical writing from the optical writing head 10 based on printing information.

Then, the electrostatic latent image is changed to a toner image (developed) using toner contained in the developing device 11 by development processing by the developing roller 12. Subsequently, the toner image acquired by the development onto the peripheral surface of the photosensitive drum 7 is directly transferred (primarily transferred) to the belt surface of the intermediate transfer belt 14 by the primary transfer roller 15 along with the rotation of the photosensitive drum 7. Then, the intermediate transfer belt 14 is conveyed to a transfer position where transfer to the release sheet 22 is performed so as to further transfer (secondarily transfer) the toner image directly transferred (primarily transferred) to the belt surface.

A belt position control mechanism 18 in FIG. 1 includes the primary transfer roller 15 constituted by a conductive foamed sponge that is pressed against the lower peripheral surface of the photosensitive drum 7 via the intermediate transfer belt 14. This belt position control mechanism 18 rotationally moves the three primary transfer rollers 15 respectively corresponding to the three image forming units 6-2, 6-3, and 6-4 in magenta (M), cyan (C), and yellow (Y) in the same period with a hook-type support shaft as its center.

Also, the belt position control mechanism 18 rotationally moves one primary transfer roller 15 corresponding to the image forming unit 6-5 in black (K) in a rotational movement period different from the period of the three primary transfer rollers 15 so that the intermediate transfer belt 14 comes in contact with or separates from the photosensitive drum 7. Similarly, the belt position control mechanism 18 rotationally moves the one primary transfer roller 15 corresponding to the image forming unit 6-1 serving as the transfer base material (T) in a rotational movement period different from the period of the three primary transfer rollers 15 so that the intermediate transfer belt 14 comes in contact with or separates from the photosensitive drum 7.

More specifically, the belt position control mechanism. 18 switches the position of the intermediate transfer belt 14 to a position for a full-color mode (the primary transfer rollers 15 corresponding to the four image forming units 6-2 to 6-5 come in contact with the intermediate transfer belt 14), a position for a monochrome mode (only the primary transfer roller 15 corresponding to the image forming unit 6-5 comes in contact with the intermediate transfer belt 14), a position for a full transfer mode (all the five primary transfer rollers 15 come in contact with the intermediate transfer belt 14), or a position for an all non-transfer mode (all the five primary transfer rollers 15 separate from the intermediate transfer belt 14).

The sheet feeding section 4 includes two sheet cassettes 21 arranged in two upper and lower stages, and a large number of cut paper-like release sheets 22 are stored in one or both of the sheet cassettes 21 in the sheet feeding section 4. A paper extraction roller 23, a feed roller 24, a blowing roller 25, and a standby conveyance roller pair 26 are arranged in the vicinity of (at the right in the drawing) of each of the sheet feed ports of the two sheet cassettes 21.

The release sheets 22 are conveyed from the sheet cassette 21 one by one by one rotation of the paper extraction roller 23, and are fed to the standby conveyance roller pair 26 via the feed roller 24 and the blowing roller 25. In the present embodiment, an image (alignment image) used for alignment of an image to be thermally transferred to a transfer target medium is first transferred and fixed to a surface of the release sheet 22 not serving as a release surface, the front and back sides of the release sheet 22 are reversed using a two-sided printing function, and the image to be thermally transferred to the transfer target medium is transferred and fixed to the release surface of the release sheet 22. Therefore, the release sheet 22 is stored in the sheet cassette 21 with the surface not serving as the release surface of the release sheet 22 up and the release surface down.

Alternatively, when the number of thermal transfer print sheets to be manufactured is small, the release sheet 22 is fed to the standby conveyance roller pair 26 via a sheet feeding roller 29 from above a Multi Paper Feeder (MPF) tray 28 mounted on an opened mounting section 27. In this case, the release sheet 22 is fed with the surface not serving as the release surface down and the release surface up.

A secondary transfer roller 30 in FIG. 1, which comes in pressure contact with the driven roller 17 via the intermediate transfer belt 14, is arranged in the paper conveyance direction (in the vertically upward direction in the drawing) of the standby conveyance roller pair 26. The intermediate transfer belt 14, the driven roller 17, and the secondary transfer roller 30 form a secondary transfer section where secondary transfer to the release sheet 22 is performed.

The fixing section 5 including a belt-type thermal fixing unit is arranged on the lower flow side (on the upper side in the drawing) of the secondary transfer section. A conveyance roller pair 31 which conveys paper after fixing from the fixing section 5, and a paper ejection roller pair 33 which ejects the conveyed paper to a paper ejection tray 32 formed on the upper surface of the apparatus are arranged on the further lower flow side of the fixing section 5.

The outer surface (right outer side surface in the drawing) of the two-sided printing conveyance unit 3 serves as an opening/closing member that is used as the right side cover of the thermal transfer print sheet manufacturing apparatus 1. The two-sided printing conveyance unit 3 includes a return path branched in the right lateral direction in the drawing from a conveyance path in an intermediate portion between the conveyance roller pair 31 and the paper ejection roller pair 33.

This return path includes a start return path 34a, an intermediate return path 34b bent downward, an end return path 34c bent in the left lateral direction for conclusively reversing returned paper, and four return roller pairs 35a, 35b, 35c, and 35d arranged halfway in the return paths. An outlet of the end return path 34c connects to a conveyance path directed toward the standby conveyance roller pair 26 corresponding to the sheet cassette 21 in a lower area in the sheet feeding section 4.

Note that, although the thermal transfer print sheet manufacturing apparatus 1 shown in FIG. 1 has a mechanism that secondarily transfers a toner image, which has been primarily transferred to the intermediate transfer belt 14, to the release sheet 22 via the intermediate transfer belt 14, the present invention is not limited thereto. The thermal transfer print sheet manufacturing apparatus 1 may have a mechanism that directly transfers a toner image to the release sheet 22.

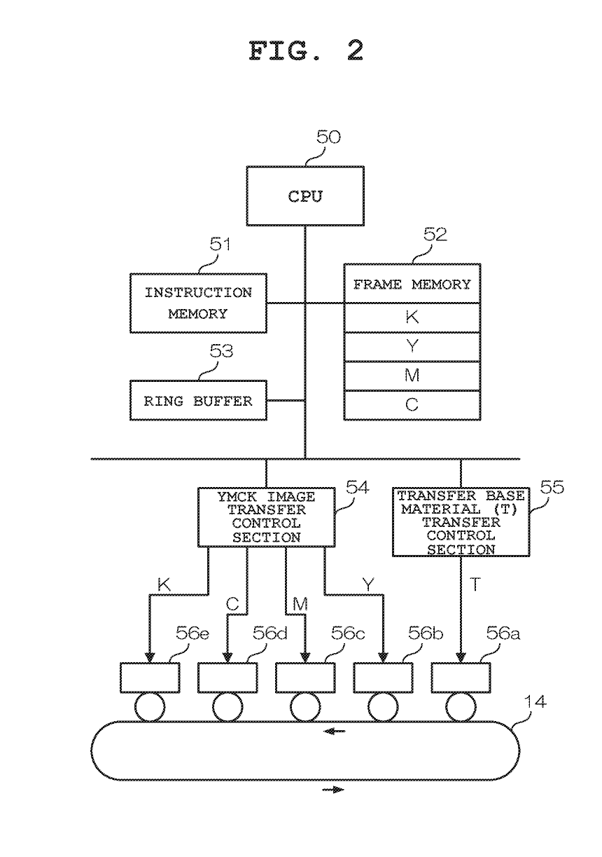

FIG. 2 is a circuit block diagram showing the controller of the thermal transfer print sheet manufacturing apparatus 1 according to the present embodiment. As shown in FIG. 2, in the circuit block, a CPU (Central Processing Unit) 50 serves as a main unit, and an instruction memory 51, a frame memory 52, a ring buffer 53, a YMCK image transfer control section 54, a transfer base material (T) transfer control section 55, and print head control sections 56a to 56e are respectively connected to the CPU 50 via data buses.

The instruction memory 51 stores a system program. The CPU 50 performs processing by controlling the respective sections in accordance with this system program. The frame memory 52 has storage areas respectively set for black (K), magenta (M), cyan (C), and yellow (Y). For example, image data supplied from a host device such as a personal computer is converted into bitmap data binarized for each color and expanded in the frame memory 52.

The CPU 50 reads out the respective color-specific image data expanded in the frame memory 52 and outputs them to the YMCK image transfer control section 54. Also, the CPU 50 reads out the respective color-specific image data expanded in the frame memory 52, generates image data on the transfer base material (T) by using the image data of black (K), magenta (M), cyan (C), and yellow (Y), and writes the data in the ring buffer 53.

The ring buffer 53 temporarily holds image data on the transfer base material (T) which is generated by using image data of black (K), magenta (M), cyan (C), and yellow (Y). In this embodiment, the ring buffer 53 has a memory capacity corresponding to six lines. The YMCK image transfer control section 54 outputs the image data of black (K), magenta (M), cyan (C), and yellow (Y) to the print head control sections 56b to 56e at predetermined timing under the control of the CPU 50. The transfer base material (T) transfer control section 55 outputs the image data on the transfer base material (T) written in the ring buffer 53 to the print head control section 56a at a predetermined timing under the control of the CPU 50.

The print head control sections 56a to 56e each are constituted by a rotation driving system (not shown) including the photosensitive drum 7 shown in FIG. 1, an image forming section having driven sections such as the charging roller 9 and the optical writing head 10, and a driving section (not shown) which vertically moves the intermediate transfer belt 14. The print head control section 56a forms a toner image based on the image data on the transfer base material (T) sent from the transfer base material (T) transfer control section 55 on the intermediate transfer belt 14. The print head control sections 56b to 56e form toner images based on image data of black (K), magenta (M), cyan (C), and yellow (Y) transferred from the YMCK image transfer control section 54 on the intermediate transfer belt 14. Accordingly, the toner image made of the transfer base material (T) is formed on the lowermost layer of the intermediate transfer belt 14, and the toner images of yellow (Y), magenta (M), cyan (C), and black (K) are formed thereon.

The toner images formed on the intermediate transfer belt 14 are sent to the secondary transfer section constituted by the driven roller 17 and the secondary transfer roller 30 shown in FIG. 1, and secondarily transferred to the release sheet 22. Accordingly, these images are transferred to the release sheet 22 with the toner image formed from the transfer base material (T) being overlaid on the toner images of yellow (Y), magenta (M), cyan (C), and black (K) (images thermally transferred to a transfer target medium).

In this embodiment, image data on a transfer base material (T) having a size larger than the area of an image to be thermally transferred to a transfer target medium is generated line by line by using image data of black (K), magenta (M), cyan (C), and yellow (Y), and the toner image of the transfer base material (T) is formed line by line on the intermediate transfer belt 14. Accordingly, as long as the ring buffer 53 which holds image data corresponding to several lines is prepared, it is not necessary to secure an area for holding the image data on the transfer base material (T) in the frame memory 52, which makes it possible to reduce the memory capacity. In addition, the present embodiment generates image data on a transfer base material (T), which has a minimum size and is accurately and uniformly wide relative to the area of an image to be thermally transferred to a transfer target medium. This provides excellent finishing after ironing printing.

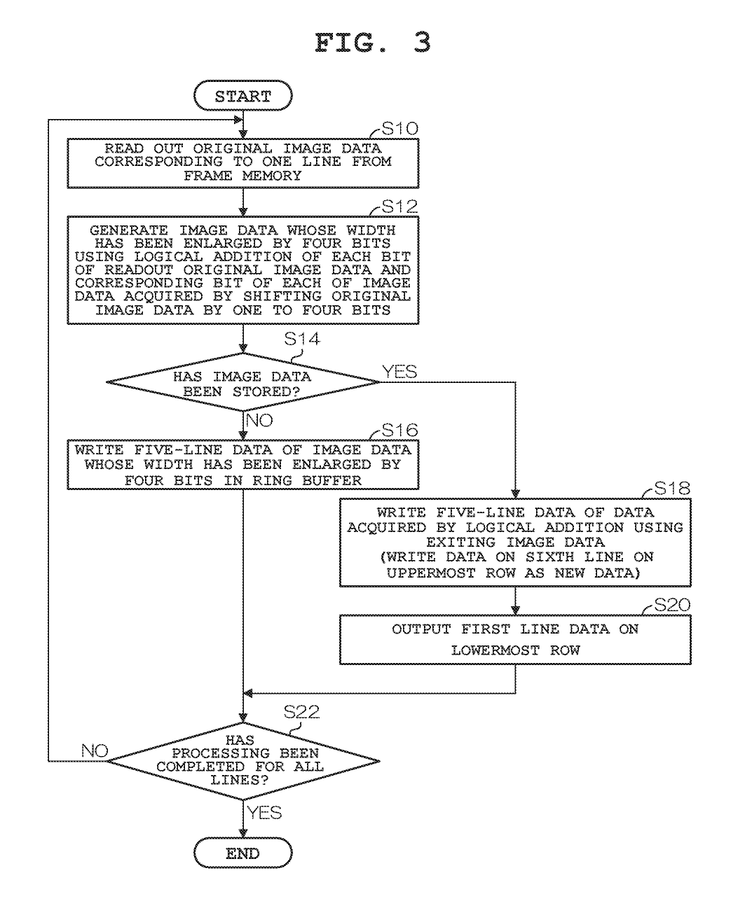

FIG. 3 is a flowchart for explaining a method of generating image data on a transfer base material (T) by using the thermal transfer print sheet manufacturing apparatus 1 according to the present embodiment. Note that, in FIG. 3, this method will be described with monochrome transfer image data as an example for convenience of explanation. First, the CPU 50 reads out image data (hereinafter referred to as original image data) corresponding to one line of transfer image data from the frame memory 52 (Step S10). Subsequently, the CPU 50 generates image data whose width is enlarged by four bits using logical addition of each bit of the readout original image data corresponding to one line and a corresponding bit of each of image data acquired by shifting the original image data by one to four bits (Step S12).

Then, the CPU 50 judges whether image data corresponding to the preceding line has already been written in the ring buffer 53 (Step S14). When judged that such image data has not been written in the ring buffer 53 (NO at Step S14), the image data whose width has been enlarged by four bits is written in the ring buffer 53 for five lines (Step S16). Next, the CPU 50 judges whether the processing for all the lines has been completed (Step S22). When judged that the processing for all the lines has not been completed (NO at Step S22), the process returns to Step S10 to repeat processing for the next line.

At Step S14, when judged that image data corresponding to the preceding line has already been written in the ring buffer 53 (YES at Step S14), the CPU 50 performs logical addition of the image data acquired by the logical addition and the image data which has already been written in the ring buffer 53, and writes identical image data corresponding to five lines on the second to sixth lines from the bottom of the ring buffer 53 (Step S18). Note that, on the sixth line on the uppermost row, the image data acquired by the logical addition is written as it is, as new data. Subsequently, the transfer base material (T) transfer control section 55 transfers image data corresponding to one line (first line on lowermost row=line during transfer) of the ring buffer 53 to the print head control section 56a, and primarily transfers the toner image of a transfer base material (T) to the intermediate transfer belt 14 on a line basis.

Then, the CPU 50 judges whether the processing for all the lines has been completed (Step S22). When judged that the processing for all the lines has not been completed (NO at Step S22), the CPU 50 returns to Step S10 to repeat the processing for the next line. When judged that the processing for all the lines has been completed (YES at Step S22), the CPU 50 ends the processing.

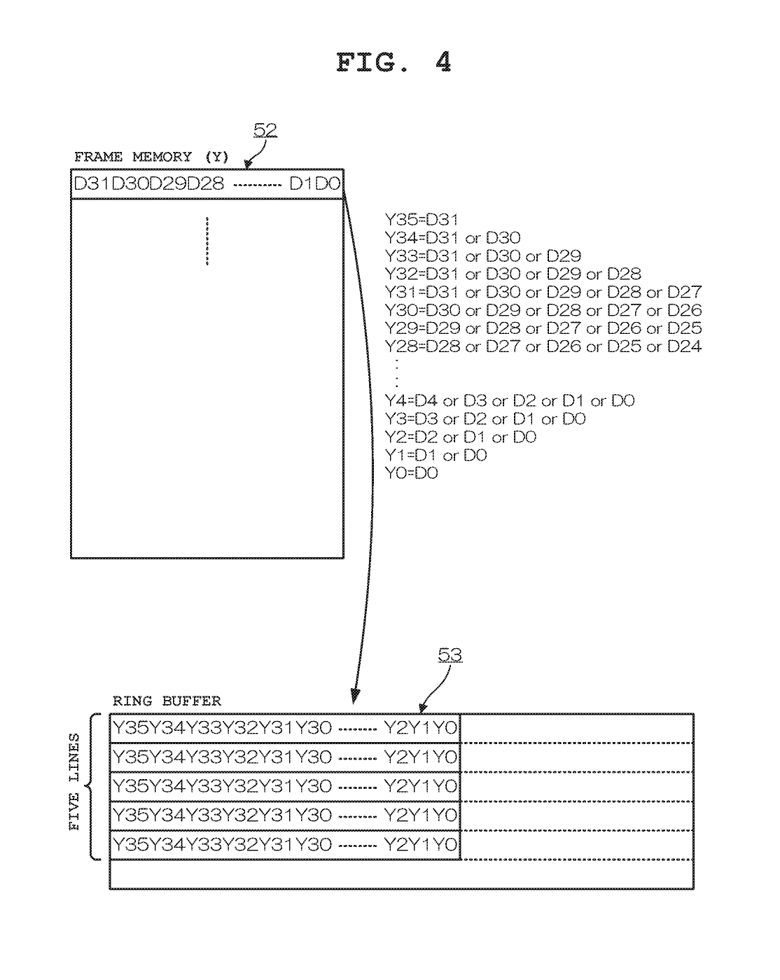

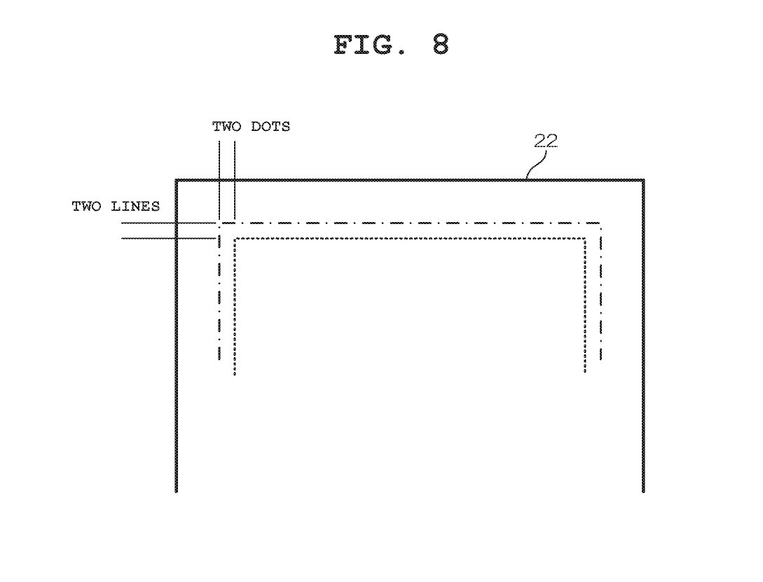

FIG. 4 to FIG. 7 are conceptual views for explaining a method of generating image data on a transfer base material (T) by using the thermal transfer print sheet manufacturing apparatus 1 according to this embodiment. FIG. 8 is a conceptual view for explaining timing at which image data on a transfer base material (T) is transmitted to the print head control section 56a by the transfer base material (T) transfer control section 55 according to the present embodiment.

First, the CPU 50 reads out image data corresponding to one word on the first line of image data of yellow (Y) from the yellow (Y) storage area in the frame memory 52. In this case, the CPU 50 may read out one-word image data of yellow (Y) after collectively reading out image data corresponding to several words on the first line from the frame memory 52 and storing the data in a temporary storage memory such as a FIFO memory.

Then, the CPU 50 writes the readout image data in the ring buffer 53 corresponding to five lines. In this case, processing such as that shown in FIG. 4 is performed. Note that FIG. 4 shows a case in which readout image data has a width of 32 bits. As shown in FIG. 4, logical operation (logical addition) is performed on image data D0 to D31 of yellow (Y) to generate image data Y0 to Y35 each of whose width has been enlarged by four bits.

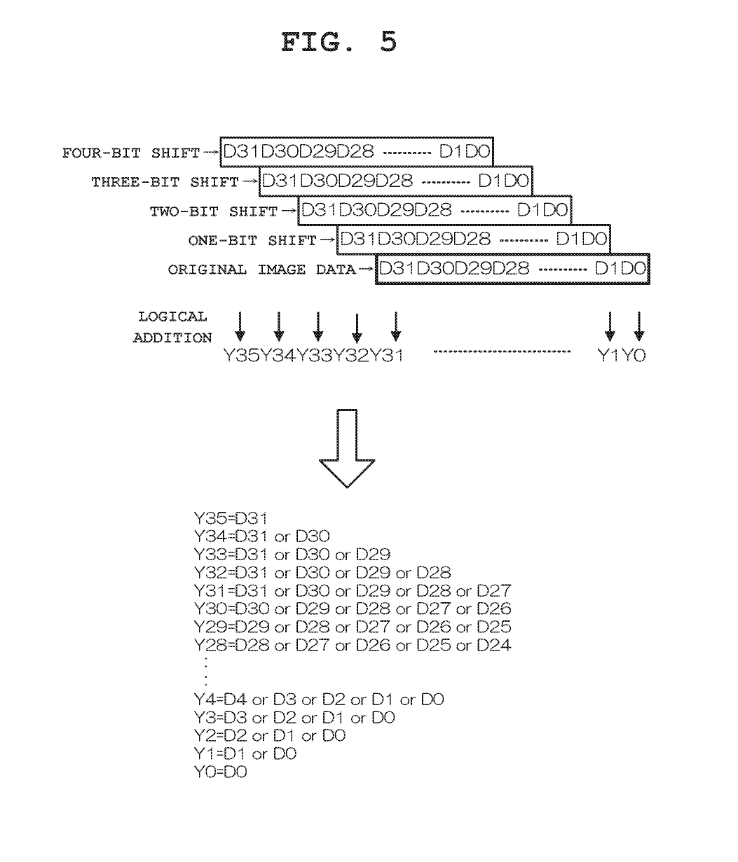

As shown in FIG. 5, the image data Y0 to Y35 is the same as that acquired by logical addition of each bit of five-word image data as the sum of the readout original image data and image data acquired by shifting the original image data by one to four bits. As shown in FIG. 4, the image data are written in the ring buffer 53 corresponding to five lines. Identical image data corresponding to five lines are written in the ring buffer 53 corresponding to five lines.

Note that the ring buffer 53 shown in FIG. 4 has a capacity corresponding to six lines. This ring buffer 53 has additional one line because it includes a line during video transfer (the lowermost line is a line during transfer). That is, it is based on an assumption that image data is written in the ring buffer 53 concurrently with the transfer of image data to the print head control section 56a. When providing a plurality of lines during video transfer, it is necessary to increase the number of lines of the ring buffer 53 accordingly.

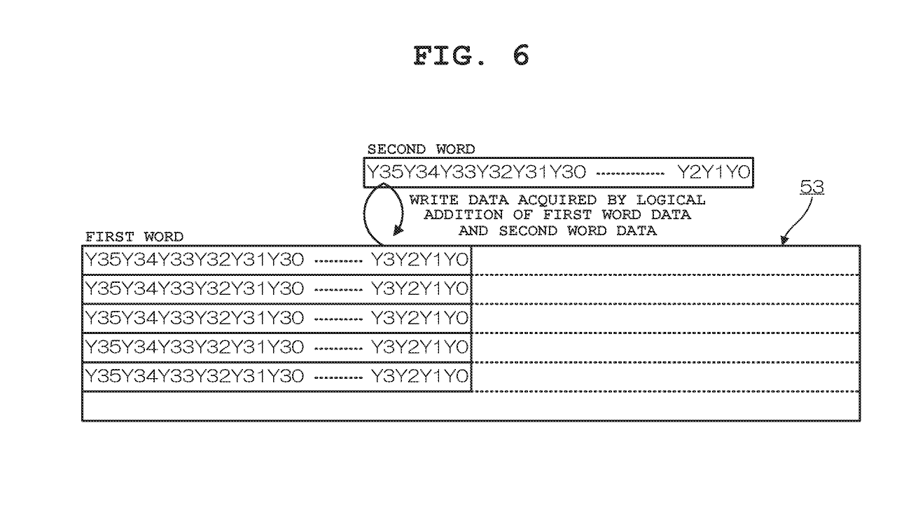

The CPU 50 performs processing similar to the above processing with respect to the second word data of the image of yellow (Y). However, when writing the data in the ring buffer 53 corresponding to five lines, the CPU 50 starts writing the data from the 32 bit boundary corresponding to the data width by which the image of yellow (Y) has been read out without locating the data adjacent to the 36-bit wide data which has already been written. In this case, as shown in FIG. 6, the CPU 50 reads out four-bit image data of the image data acquired by processing and enlarging the first word data which has already been written. The CPU 50 then performs logical addition of the readout data and the image data acquired by processing the second word data, and writes the resultant data as five-line image data in the ring buffer 53. The CPU 50 repeats this processing by the data width of one line of the original image data.

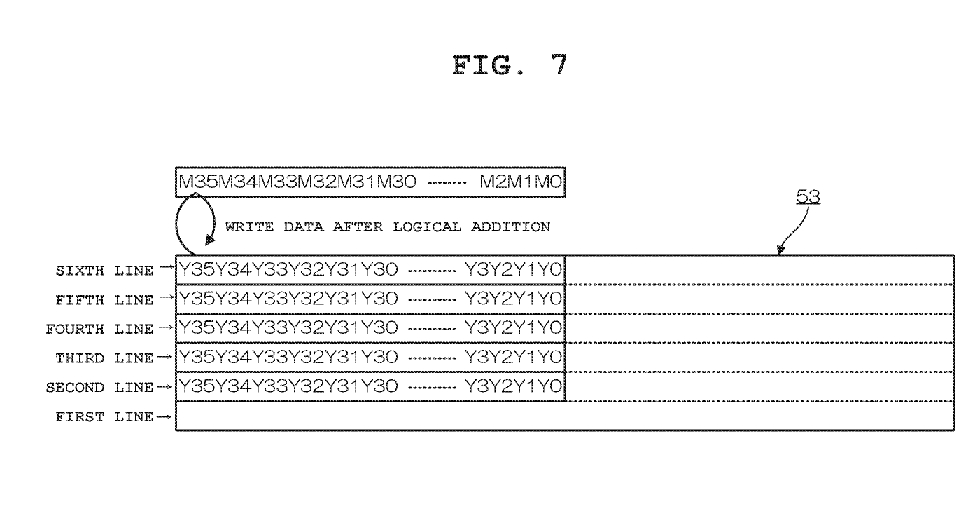

The CPU 50 also performs processing similar to the above processing with respect to the image of magenta (M). However, when writing the image data in the ring buffer 53, the CPU 50 writes the data in the ring buffer 53 while performing logical addition of the data and the image data of yellow (Y) which has already been written, as shown in FIG. 7. The CPU 50 also writes the image data of cyan (C) and black (K) in the ring buffer 53 while performing logical addition in the same manner as described above. As a result, five-line image data on the transfer base material (T) is generated in the ring buffer 53 with respect to one-line original image data.

At the timing of printing the toner image of the transfer base material (T), the transfer base material (T) transfer control section 55 moves the above five-line image data to the first line to the fifth line counted from the bottom of the ring buffer 53, and transfers image data corresponding to one line (first line on lowermost row=line during transfer) of the ring buffer 53 to the print head control section 56a. At this time, as shown in FIG. 8, the transfer base material (T) transfer control section 55 starts transferring the image data on the transfer base material (T) earlier by two lines in the vertical direction (shift in the sub-scanning direction (conveying direction)) and earlier by two dots in the horizontal direction (shift in the main scanning direction). As a result, the first line of the toner image of the transfer base material (T) is primarily transferred to the intermediate transfer belt 14.

When the data transfer is started, the transfer base material (T) transfer control section 55 writes the second line image data of yellow (Y) in the ring buffer 53 in the same manner as described above with the line during transfer as the first line. In this case, the transfer base material (T) transfer control section 55 writes identical image data corresponding to five lines while performing logical addition of the data and the contents which have already been written in the ring buffer 53. That is, the five-line image data to be written are written on the second line to the sixth line counted from the bottom. Note that the sixth line on the uppermost row is new data, and therefore is written in the same manner as that of the first line of the original image data of yellow (Y) described above. In this manner, the transfer base material (T) transfer control section 55 also writes the second line of the original image data concerning the respective colors of Y, M, C, and K in the ring buffer 53.

At the next timing of printing the toner image of the transfer base material (T), the transfer base material (T) transfer control section 55 moves the above five-line image data to the first line to fifth line counted from the bottom of the ring buffer 53, and transfers image data corresponding to one line (first line on lowermost row=line during transfer) of the ring buffer 53 to the print head control section 56a. As a result, the second line of the toner image of the transfer base material (T) is primarily transferred to the intermediate transfer belt 14.

The image data on the transfer base material (T) in a range wider than the original image data by two dots in each of the upward, downward, leftward, and rightward directions can be printed on the release sheet 22 by repeating the above processing. This image data on the transfer base material (T) is larger than the original image data by four dots in the width direction of the sheet (two dots in each of the leftward and rightward directions) and four lines in the height direction (two dots in each of the upward and downward directions) regardless of the shape of the original image data.

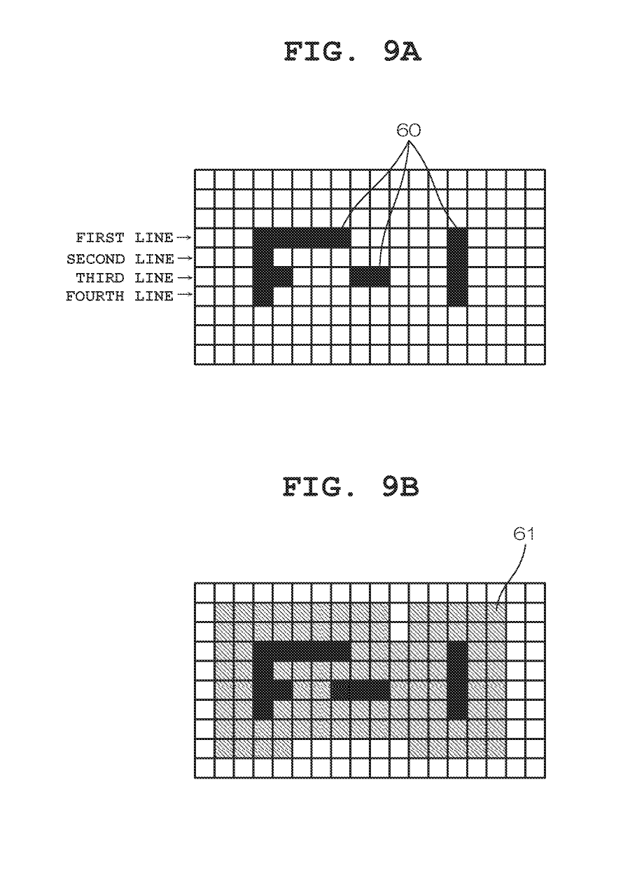

FIG. 9A and FIG. 9B are conceptual views showing a toner image based on original image data and a toner image of a transfer base material (T) which is to be generated with respect to the original image data. Note that FIG. 9A and FIG. 9B show monochrome original image data for convenience of explanation. FIG. 9A shows a toner image 60 based on the original image data, in which each black square indicates a portion having a toner image portion, and each blank square indicates a portion having no toner image portion. With respect to this original image data, a toner image 61 of the transfer base material (T) with the minimum size is preferably formed around the toner image 60 of the original image data, as indicated by the hatched squares shown in FIG. 9B.

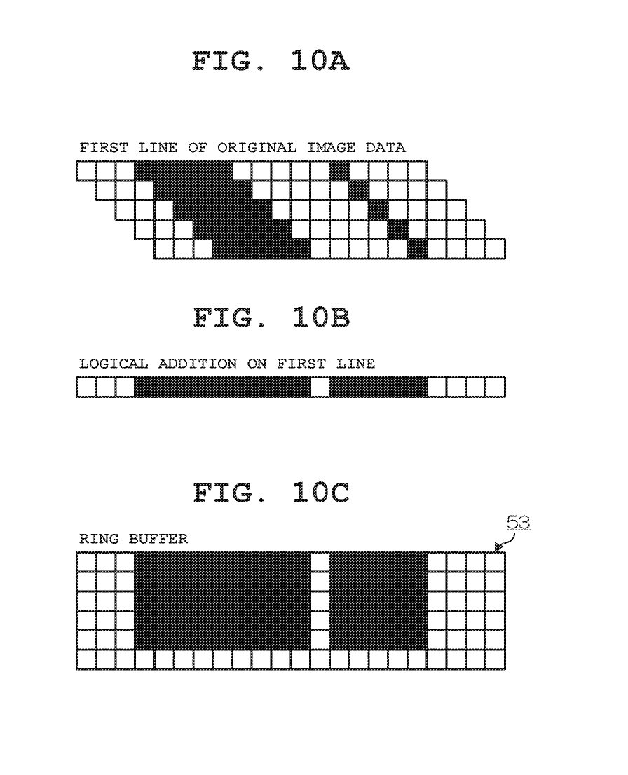

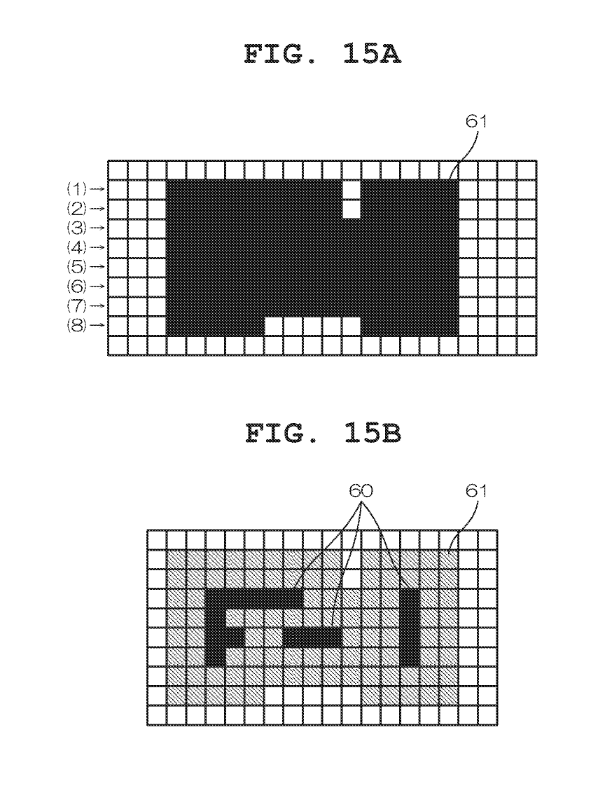

FIG. 10A to FIG. 10C, FIG. 15A, and FIG. 15B are conceptual views for explaining a method of generating image data on a transfer base material (T) according to this embodiment. Note that, in FIG. 10A to FIG. 10C, FIG. 15A, and FIG. 15B, the method is described with monochrome original image data as an example for convenience of explanation. First, with respect to the first line of the original image data shown in FIG. 9A, the image data shown in FIG. 10B is generated by logical addition of each bit of five-word image data as the sum of the readout original image data and image data acquired by shifting the original image data by one to four bits. As shown in FIG. 10C, the image data are then written as identical image data corresponding to five lines in the ring buffer 53.

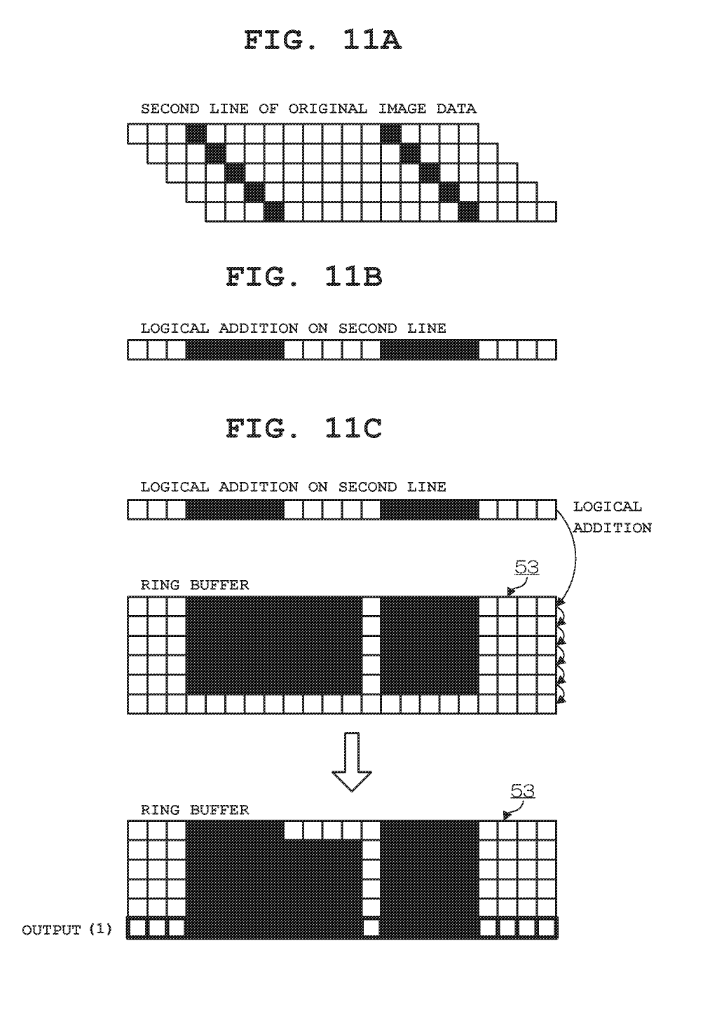

Subsequently, with respect to the second line of the original image data shown in FIG. 9A, the image data shown in FIG. 11B is generated by logical addition of each bit of five-word image data as the sum of the readout original image data and image data acquired by shifting the original image data by one to four bits. As shown in FIG. 11C, identical image data corresponding to five lines are written on the second line to the sixth line counted from the bottom of the ring buffer 53 after logical addition of the image data acquired by the logical addition and the image data which has already been written in the ring buffer 53. However, the sixth line on the uppermost row is new data, and therefore the image data shown in FIG. 11B is written as it is.

Then, the transfer base material (T) transfer control section 55 transfers image data corresponding to one line (first line on lowermost row=line during transfer) of the ring buffer 53 to the print head control section 56a. By this operation, the first line (1) of the toner image 61 of the transfer base material (T) is primarily transferred to the intermediate transfer belt 14, as shown in FIG. 15A.

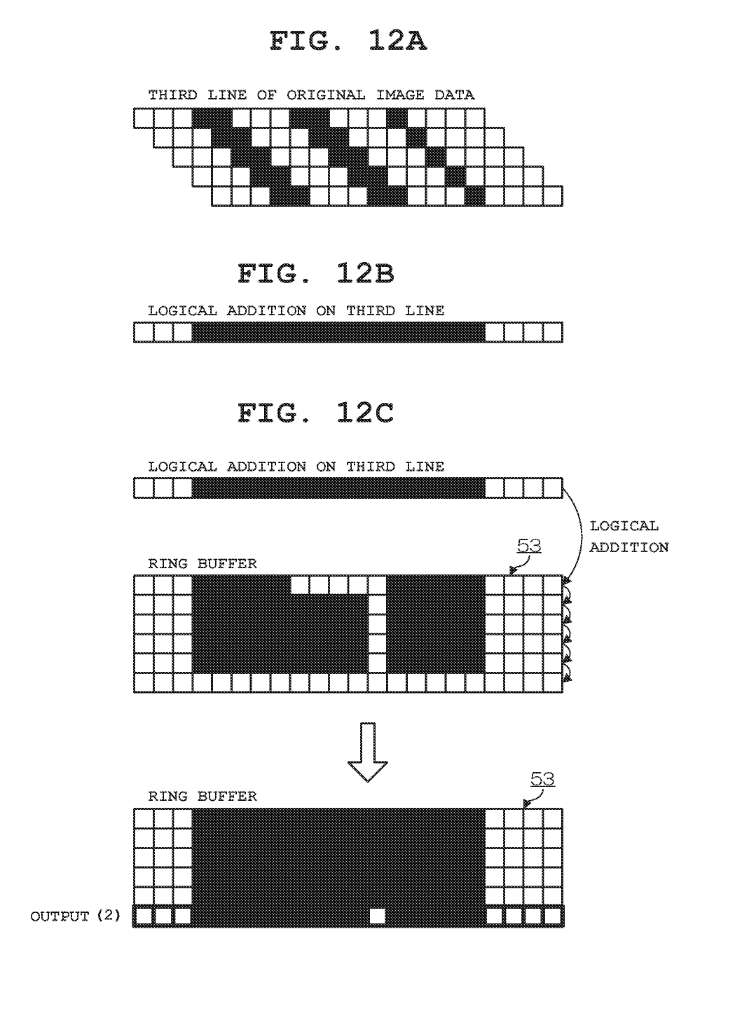

Subsequently, with respect to the third line of the original image data shown in FIG. 9A, the image data shown in FIG. 12B is generated by logical addition of each bit of five-word image data as the sum of the readout original image data and image data acquired by shifting the original image data by one to four bits. Then, as shown in FIG. 12C, identical image data corresponding to five lines are written on the second line to the sixth line counted from the bottom of the ring buffer 53 after logical addition of the image data acquired by the logical addition and the image data which has already been written in the ring buffer 53. However, the sixth line on the uppermost row is new data, and therefore the image data shown in FIG. 12B is written as it is.

Then, the transfer base material (T) transfer control section 55 transfers image data corresponding to one line (first line on lowermost row=line during transfer) of the ring buffer 53 to the print head control section 56a. As a result, as shown in FIG. 15A, the second line (2) of the toner image 61 of the transfer base material (T) is primarily transferred to the intermediate transfer belt 14.

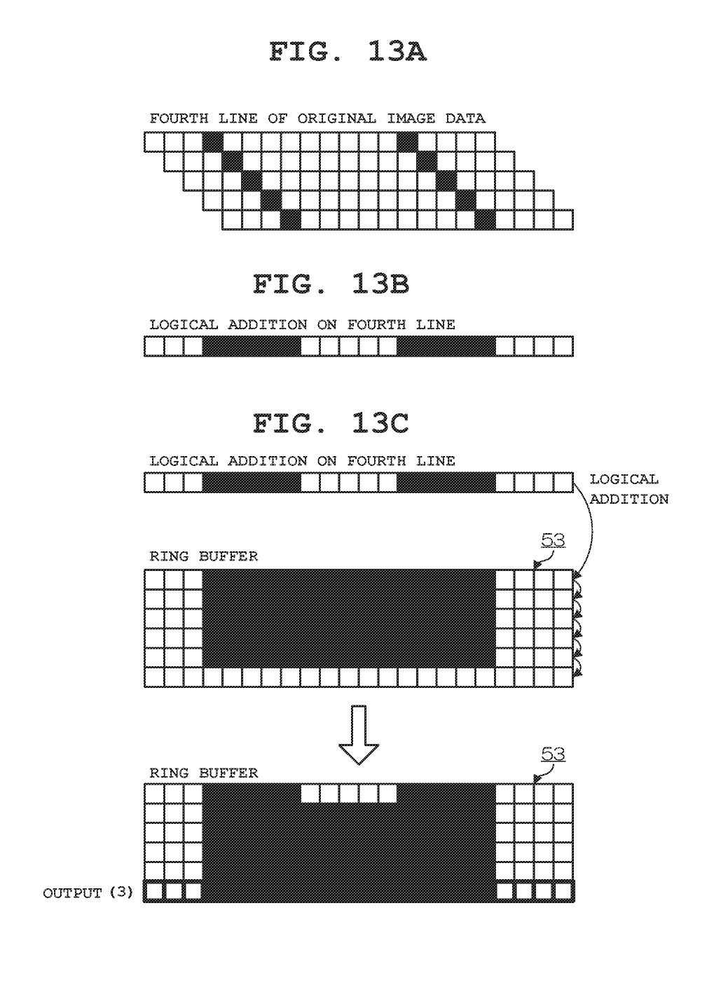

Subsequently, with respect to the fourth line of the original image data shown in FIG. 9A, the image data shown in FIG. 13B is generated by logical addition of each bit of five-word image data as the sum of the readout original image data and image data acquired by shifting the original image data by one to four bits as shown in FIG. 13A. Then, as shown in FIG. 13C, identical image data corresponding to five lines are written on the second line to the sixth line counted from the bottom of the ring buffer 53 after logical addition of the image data acquired by the logical addition and the image data which has already been written in the ring buffer 53. However, the sixth line on the uppermost row is new data, and therefore the image data shown in FIG. 13B is written as it is.

Then, the transfer base material (T) transfer control section 55 transfers image data corresponding to one line (first line on lowermost row=line during transfer) of the ring buffer 53 to the print head control section 56a. As a result, as shown in FIG. 15A, the third line (3) of the toner image 61 of the transfer base material (T) is primarily transferred to the intermediate transfer belt 14.

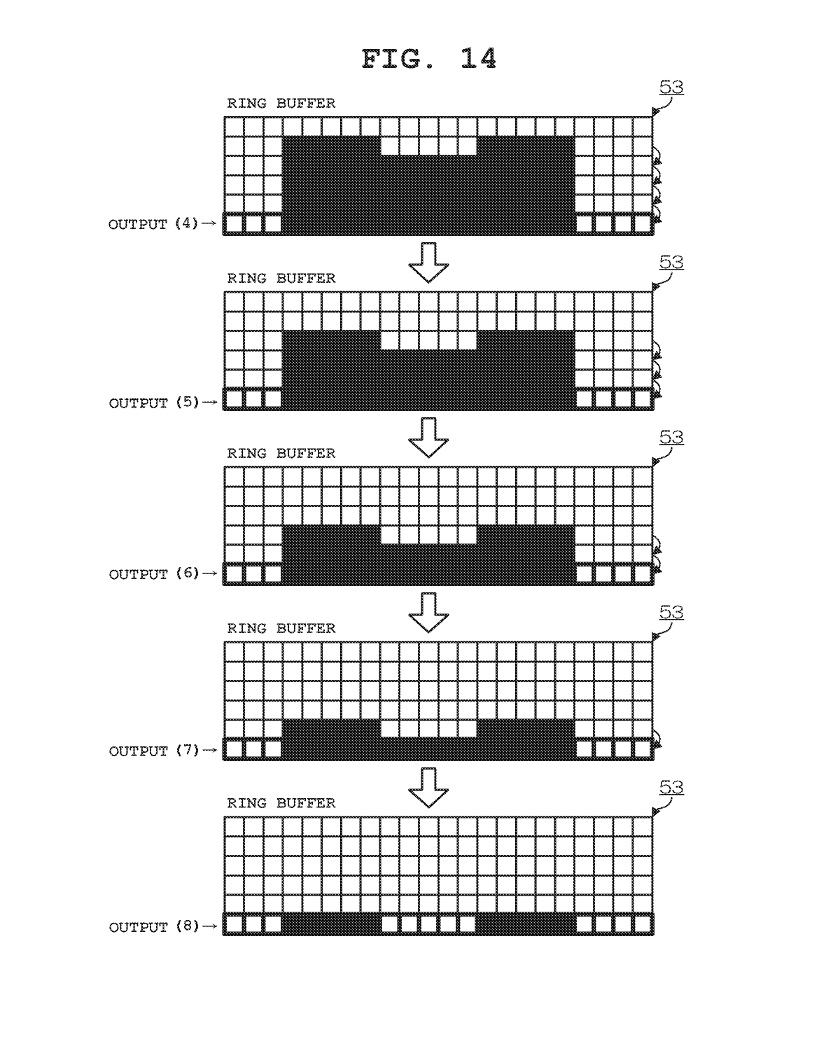

Then, since there is no original image data to be read out, image data corresponding to one line (first line on lowermost row=line during transfer) written in the ring buffer 53 is sequentially transferred to the print head control section 56a, as shown in FIG. 14. As a result, as shown in FIG. 15A, the fourth line (4), fifth line (5), sixth line (6), seventh line (7), and eighth line (8) of the toner image 61 of the transfer base material (T) are sequentially primarily transferred to the intermediate transfer belt 14. As a result, the toner image 61 of the transfer base material (T) acquired in the present embodiment and shown in FIG. 15A is formed into the toner image 61 of the transfer base material (T) with the minimum size formed around the toner image 60 based on the original image data, as shown in FIG. 15B.

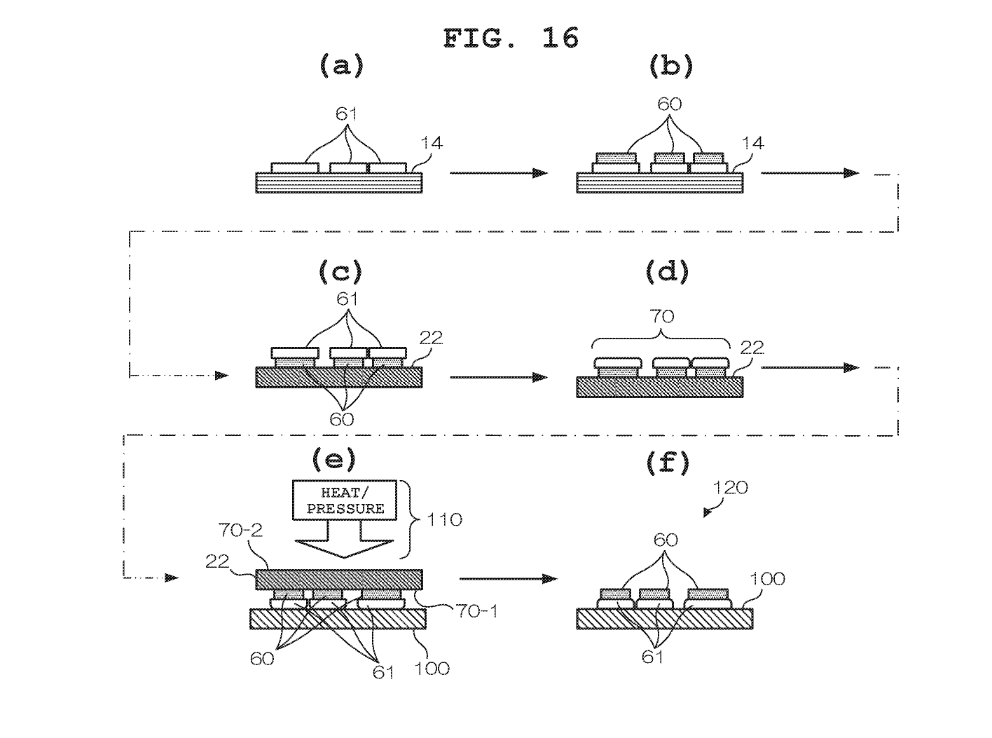

FIG. 16 is a schematic view for explaining the process of manufacturing a thermal transfer print sheet and the process of transferring an image according to the present embodiment. In the first process, the toner image 61 of a transfer base material (T) which has been enlarged by two dots in the main scanning direction and two lines in the sub-scanning direction to the intermediate transfer belt 14 is primarily transferred, as shown in drawing (a) of FIG. 16. In the second process, the toner image (mirror image) 60 of an image to be transferred to and printed on a transfer target medium such as a T-shirt is primarily transferred to the toner image 61 of the transfer base material (T) on the intermediate transfer belt 14, as shown in drawing (b) of FIG. 16.

Next, in the third process, the toner image 61 of the transfer base material (T) and the toner image (mirror image) 60 of the image to be transferred an printed, which have been primarily transferred to the intermediate transfer belt 14, is secondarily transferred to the release sheet 22, as shown in drawing (c) of FIG. 16. At this stage, the toner image (mirror image) 60 of the image to be transferred and printed and the toner image 61 of the transfer base material (T) are sequentially overlaid on the release sheet 22 from bottom to top.

In the fourth process, the release sheet 22, to which the toner image (mirror image) 60 of the image to be transferred and printed and the toner image (mirror image) 61 of the transfer base material have been transferred with the toner image (mirror image) 61 being superimposed and on the toner image (mirror image) 60, is loaded into the fixing section 5, and the toner image (mirror image) 60 of the image to be transferred and printed and the toner image (mirror image) 61 of the transfer base material are fixed, as shown in drawing (d) of FIG. 16. That is, in the processing from the first process to the fourth process described above, a thermal transfer print sheet 70 constituted by the release sheet 22, the toner image (mirror image) 60, and the toner image (mirror image) 61 of the transfer base material is created.

Then, the thermal transfer print sheet 70 is made to adhere to a transfer target medium 100 such as a T-shirt via the toner image (mirror image) 61 of the transfer base material made of a thermoplastic resin having the same shape as that of the toner image (mirror image) 60 of the image to be transferred and printed by superimposing the thermal transfer print sheet 70 on the transfer target medium 100 with a mirror image formation surface 70-1 opposing the transfer target medium 100, and heating and pressing a reverse surface 70-2 of the mirror image formation surface of the thermal transfer print sheet 70 by using a commercially available hot press 110, as shown in drawing (e) of FIG. 16.

Note that the thermal transfer print sheet 70 may be made to adhere to the transfer target medium 100 by manual ironing without using the hot press 110.

Then, when the release sheet 22 is manually separated after the thermal transfer print sheet 70 is cooled to about room temperature as shown in drawing (f) of FIG. 16, a transfer image 120 where the toner image (mirror image) 60 of the image to be transferred and printed is a normal image is created on the transfer target medium 100 that is a print target such as a T-shirt. The toner image (mirror image) 61 of the transfer base material is equally enlarged by two dots and two lines relative to the toner image (mirror image) 60, whereby the transfer image 120 with excellent finishing is acquired.

In the above-described embodiment, the toner image 61 of the transfer base material (T) enlarged leftward, rightward, upward, and downward for each line is created from the original image. As a result of this configuration, there is no need to secure, in the frame memory 52, a storage area where the entire toner image (mirror image) 61 of a transfer base material (T) is expanded, which makes it possible to reduce the memory capacity.

Also, in the above-described embodiment, the toner image (mirror image) 61 of the transfer base material (T) enlarged by a predetermined amount upward, downward, leftward, and rightward is created from the original image data. As a result of this configuration, it is possible to generate image data on a transfer base material which has the minimum size corresponding to the outer shape of a transfer image and is equally enlarged, whereby excellent finishing quality after ironing is achieved.

Moreover, in the above-described embodiment, when generating a plurality of image data by shifting one-line image data of transfer image data in the main scanning direction, enlarging the image data on a transfer base material in the leftward and rightward directions by logical addition of each bit of the plurality of image data, and writing the image data enlarged in the leftward and rightward directions in the ring buffer 53, image data on the transfer base material enlarged in the upward and downward directions by copying or logical addition is generated. As a result of this configuration, image data on a transfer base material can be generated by enlarging transfer image data upward, downward, leftward, and rightward even with a small memory capacity.

Furthermore, in the above-described embodiment, when transferring image data corresponding to one line (first line on lowermost row=line during transfer) of the ring buffer 53 to the print head control section 56a, the transfer control section starts transferring the image data earlier by two lines in the vertical direction (shift in the sub-scanning direction (conveying direction)) and earlier by two dots in the horizontal direction (shift in the main scanning direction). As a result of this configuration, it is possible to generate image data on a transfer base material which has the minimum size corresponding to the outer shape of a transfer image and is equally enlarged, whereby excellent finishing quality after ironing is achieved.

Still further, in the above-described embodiment, image data on a transfer base material is generated by enlarging transfer image data for each constituent color by a predetermined amount upward, downward, leftward, and rightward for each line. As a result of this configuration, it is possible to generate image data on a transfer base material enlarged upward, downward, leftward, and rightward even from transfer image data having a complicated color structure.

The above-described embodiment includes a toner of a transfer base material (T) in addition to toners of magenta (M), cyan (C), yellow (Y), and black (K). In the case where toners of magenta (M), cyan (C), and yellow (Y) are included, the apparatus may be loaded with a toner of a transfer base material (T) in place of a toner of black (K), whereby an existing image forming apparatus can be used without any alteration.

Also, in the above-described embodiment, image data on a transfer base material is generated by shifting each of image data of magenta (M), cyan (C), yellow (Y), and black (K) constituting original image data by a predetermined amount upward, downward, leftward, and rightward and performing logical addition of the resultant data. However, the present invention is not limited thereto. Image data on a transfer base material may be generated by binarizing original image data, shifting the binarized image data by a predetermined amount upward, downward, leftward, and rightward, and performing logical addition of the resultant data.

While the present invention has been described with reference to the preferred embodiments, it is intended that the invention be not limited by any of the details of the description therein but includes all the embodiments which fall within the scope of the appended claims.

What is claimed is:

1. A manufacturing apparatus for a thermal transfer print sheet provided with a toner layer that serves as a transfer image to be thermally transferred to a transfer target medium and an adhesive transfer base material layer, the manufacturing apparatus comprising:
an acquisition section which acquires area information regarding an area occupied by the transfer image;
a derivation section which derives an area enlarged so as to include at least the area occupied by the transfer image and have an area shape corresponding to the transfer image, based on the area information acquired by the acquisition section; and
a generation section which generates the transfer base material layer on the enlarged area, which is derived by the derivation section.

2. The manufacturing apparatus according to claim 1, wherein the transfer base material layer includes a thermoplastic resin.

3. The manufacturing apparatus according to claim 1, wherein the generation section generates, on a releasable sheet, a thermal transfer print sheet where the toner layer and the transfer base material layer are laminated from bottom to top.

4. The manufacturing apparatus according to claim 1, wherein the acquisition section acquires area information regarding an area occupied by the transfer image for each line in a main scanning direction, and
wherein the derivation section enlarges, based on the area information acquired for each line by the acquisition section, the area represented by the area information in the main scanning direction.

5. The manufacturing apparatus according to claim 4, wherein the derivation section enlarges, based on the area information acquired for each line by the acquisition section, the area represented by the area information in the main scanning direction by moving and adding the area represented by the area information by a predetermined width in the main scanning direction.

6. The manufacturing apparatus according to claim 4, wherein the derivation section derives the enlarged area by enlarging the area, which has been enlarged in the main scanning direction, in a sub-scanning direction.

7. The manufacturing apparatus according to claim 6, wherein the derivation section derives the enlarged area by moving and adding the area, which has been enlarged in the main scanning direction, by a predetermined length in the sub-scanning direction.

8. The manufacturing apparatus according to claim 6, wherein the derivation section comprises an output section which outputs information representing the enlarged area derived by the derivation section to the generation section for each line in the main scanning direction.

9. A manufacturing apparatus for a thermal transfer print sheet provided with a toner layer that serves as an image to be thermally transferred to a transfer target medium and an adhesive transfer base material layer, the manufacturing apparatus comprising:
a first storage section which holds data of an image to be thermally transferred as transfer image data;
a generation section which generates image data on the transfer base material by enlarging the transfer image data in the first storage section for each line;
a second storage section which temporarily holds the image data on the transfer base material generated by the generation section in units of predetermined number of lines; and
an output section which outputs the image data on the transfer base material held in the second storage section for each line.

10. The manufacturing apparatus according to claim 9, wherein the transfer base material layer includes a thermoplastic resin.

11. The manufacturing apparatus according to claim 9, wherein the first storage section binarizes the data of the image to be thermally transferred and holds the data as transfer image data, and
wherein the generation section generates image data on the transfer base material which has been enlarged in a leftward direction and a rightward direction, by (i) generating a plurality of image data by shifting one-line image data of the binarized transfer image data in a main scanning direction, and (ii) performing logical addition of each bit of the plurality of image data.

12. The manufacturing apparatus according to claim 9, wherein the generation section generates image data on the transfer base material which has been enlarged in an upward direction and a downward direction, by adding new lines acquired by logical addition of each bit of adjacent lines of the image data on the transfer base material which has been enlarged in the leftward direction and the rightward direction.

13. The manufacturing apparatus according to claim 9, wherein the first storage section binarizes the data of the image to be thermally transferred and holds the data as transfer image data, and
wherein the generation section enlarges image data on the transfer base material in a leftward direction and a rightward direction by (i) generating a plurality of image data by shifting one-line image data of the binarized transfer image data in a main scanning direction and (ii) performing logical addition of each bit of the plurality of image data, and
wherein the generation section enlarges the image data on the transfer base material in an upward direction and a downward direction by (i) writing a plurality of image data on the transfer base material which have been enlarged in the leftward direction and the rightward direction in the second storage section when writing the image data on the transfer base material which has been enlarged in the leftward direction and the rightward direction in the second storage section where image data on a preceding line is not present, or (ii) by writing, in the second storage section where the image data on the preceding line is already present, image data acquired by logical addition of each bit of the image data on the transfer base material which has been enlarged in the leftward direction and the rightward direction and a corresponding bit of the image data on the transfer base material on the preceding line which has already been written in the second storage section, as image data on the transfer base material on a subsequent line.

14. The manufacturing apparatus according to claim 9, wherein the output section shifts output timing of the image data on the transfer base material held in the second storage section in a main scanning direction and a sub-scanning direction based on an amount of enlargement by the generation section.

15. The manufacturing apparatus according to claim 9, wherein the transfer image data is constituted by at least one of colors including yellow (Y), magenta (M), and cyan (C) or a color acquired by combining the colors, and
wherein the generation section generates image data on the transfer base material by enlarging the transfer image data for each constituent color for each line in upward, downward, leftward, and rightward directions.

16. The manufacturing apparatus according to claim 15, wherein the generation section generates image data on the transfer base material which has been enlarged in the leftward direction and the rightward direction by (i) generating a plurality of image data by shifting one-line image data of the transfer image data in a main scanning direction for each of the colors constituting the transfer image data, and (ii) performing logical addition of each bit of the plurality of image data.

17. A manufacturing method for a thermal transfer print sheet provided with a toner layer that serves as a transfer image to be thermally transferred to a transfer target medium and an adhesive transfer base material layer, the manufacturing method comprising:
acquiring area information regarding an area occupied by the transfer image;
deriving an area enlarged so as to include at least the area occupied by the transfer image and have an area shape corresponding to the transfer image, based on the area information; and
generating the transfer base material layer on the enlarged area.

18. The manufacturing method according to claim 17, wherein the deriving (i) generates image data on the transfer base material by reading out data of the transfer image for each line and enlarging the data for each line, (ii) temporarily holds the generated image data on the transfer base material in units of predetermined number of lines, and (iii) outputs the held image data on the transfer base material for each line, and
wherein the generating generates the transfer base material layer in the enlarged area represented by the image data on the transfer base material outputted for each line.
